(19) United States
(12) Patent Application Publication
(10) Pub. No.: US 2010/0261859 A1
(43) Pub. Date: Oct. 14, 2010

(54) CATALYST COMPONENTS FOR THE POLYMERIZATION OF OLEFINS

(75) Inventors: Paolo Vincenzi, Ficarolo (IT); Giovanni Patroncini, Ferrara (IT)

Correspondence Address: LyondellBasell Industries, 3801 WEST CHESTER PIKE, NEWTOWN SQUARE, PA, 19073, US

(73) Assignee: Basell Poliolefine Italia s.r.l., Milan (IT)

(21) Appl. No.: 12/735,147

(22) PCT Filed: Dec. 9, 2008
(86) PCT No.: PCT/EP2008/067118

§ 371 Date: Jun. 18, 2010

Related U.S. Application Data
(60) Provisional application No. 61/008,677, filed on Dec. 21, 2007.

(30) Foreign Application Priority Data
Dec. 20, 2007 (EP) 07150186.0

(51) Int. Cl. C08F 4/76; B01J 31/14

(52) U.S. Cl. 526/125.4; 526/113; 502/170; 502/158; 502/127

(57) ABSTRACT

Catalyst component having average particle size equal to or lower than 40 μm comprising a magnesium halide, a titanium compound having at least a Ti-halogen bond and at least two electron donor compounds one of which being present in an amount from 15 to 50% by mol with respect to the total amount of donors and selected from succinates of formula (I) below

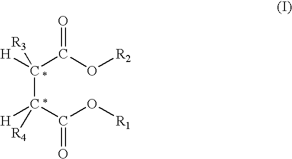

in which the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C3-C20 cycloalkyl, C5-C20 aryl, arylalkyl or alkylaryl group with the proviso that at least one of them is a branched alkyl; said compounds being, with respect to the two asymmetric carbon atoms identified in the structure of formula (I), stereoisomers of the type (S,R) or (R,S) and at least another electron donor compound which is extractable, under the test of extractability disclosed in the characterization section, for more than 30% by mol

This application is the U.S. national phase of International Application PCT/EP2008/067118, filed Dec. 9, 2008, claiming priority to European Patent Application 07150186.0 filed Dec. 20, 2007, and the benefit under 35 U.S.C. 119(e) of U.S. Provisional Application No. 61/008,677, filed Dec. 21, 2007; the disclosures of International Application PCT/EP2008/067118, European Patent Application 07150186.0 and U.S. Provisional Application No. 61/008,677, each as filed, are incorporated herein by reference.

The present invention relates to catalyst components for the polymerization of olefins, in particular propylene, having a specific average particle size and comprising a Mg dihalide, a Ti compound having at least one Ti-halogen bond and at least two electron donor compounds selected from specific classes. The present invention further relates to a gas-phase process for the polymerization of olefins carried out in the presence of a catalyst system comprising said catalyst component.

The behaviour of a gas phase reactor is well known in the art. When correctly operated this kind of polymerization technique is able to give polymers endowed with good properties with a relatively low investment cost. In gas-phase reactors the reactor throughput is proportional to the amount of polymerization heat that can be removed from the fluidised bed. Heat is exchanged by means of the recirculation gas and in some processes a partial condensation occurs and the resulting liquid is injected into the polymer bed. In this case it can be said that the process is operating in condensing mode.

Reactor throughput is generally pushed to its maximum by increasing gas mass flow rate up to the value allowed by limit fluidization gas velocity. Exceeding this limit, a significant portion of polymer particles is entrained by recirculation gas: as a consequence, gas recirculation pipe and fan sheeting occurs, heat exchangers tubes and distribution grid plug. As a consequence, the maintenance cost becomes higher, the manufacturing time longer and production losses are also involved.

The entrainment velocity is a direct function of particle size and density. Bigger and/or denser particles allow higher fluidization gas velocity and therefore, in order to optimize the gas velocity, polymer density should be kept up to the maximum value allowed by final application grade, while small polymeric fraction is to be avoided.

Small polymeric fractions, so called fines fine particles (usually considered those having diameter or radius lower than 125 μm), are generated when, due to the high activity during the initial stages of polymerization, the catalyst becomes irregularly fragmented. According to general knowledge another source of small particles can be represented by the use of catalyst precursors having a small average particle diameter, such as lower than 30 μm particularly, as explained in EP-B-713888, in combination with a broad particle size distribution.

It is known to the skilled in the art and described in many publications such as EP-A-541760, that in order to solve these problems, it is advised to use catalyst precursors having average particle size higher than 30 μm that need to be prepolymerized under controlled conditions so as to obtain prepolymerized catalysts having controlled morphology. After prepolymerization, the catalyst particles become bigger and also increase their resistance in such a way that the tendency to break under polymerization conditions is decreased. As a consequence, the catalyst is able to produce bigger polymer particles and also the formation of fines is reduced. However, by effect of prepolymerization, the catalyst activity often becomes reduced and this partially thwarts the efforts to obtain higher productivity with the use of larger prepolymerized catalyst particles.

Now it has been surprisingly found that a catalyst component having average particle size lower than 40 μm and comprising Mg, Ti, a succinate of specific formula and an another ester donor having certain extractability features, exhibits a very high activity together with enhanced morphological stability without the need of being prepolymerized.

Catalyst components comprising a support made of magnesium chloride on which a titanium compound and a specific couple of electron donors selected from esters of succinic acids that are not extractable under certain conditions and esters of carboxylic acid that are extractable under the same conditions are disclosed in WO02/30998. This document addresses the fact that these catalysts allow obtaining propylene polymers with high values of xylene insolubility combined with broad range of isotacticity and with a particularly high content of stereoblocks. The possibility of using the said catalyst in gas-phase polymerization is only generically mentioned together with other techniques. Nowhere is discussed or mentioned the average size of the catalysts, and, most of all, nowhere is discussed or addressed the technical problem associated with the use of said catalysts in gas-phase polymerization.

Accordingly, it is an object of the present invention a catalyst component having average particle size equal to or lower than 40 μm comprising a magnesium halide, a titanium compound having at least a Ti-halogen bond and at least two electron donor compounds one of which being present in an amount from 15 to 50% by mol with respect to the total amount of donors and selected from succinates of formula (I) below

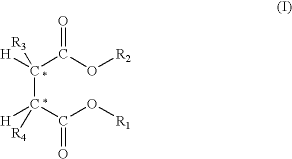

in which the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C3-C20 cycloalkyl, C5-C20 aryl, arylalkyl or alkylaryl group with the proviso that at least one of them is a branched alkyl; said compounds being, with respect to the two asymmetric carbon atoms identified in the structure of formula (I), stereoisomers of the type (S,R) or (R,S) and at least another electron donor compound which is extractable, under the test of extractability disclosed in the characterization section, for more than 30% by mol. According to the present invention, the electron donor compounds extractable for more than 30% by mol will be defined as extractable electron donor compounds. Preferably, the amount of succinates of formula (I) is between 20 and 45 and more preferably from 22 to 40% by mol with respect to the total amount of the electron donor compounds.

Preferably, the said catalyst has an average particle size lower than 35 μm and more preferably lower than 30 μm.

In a preferred embodiment is used a succinate of formula (I) which is not extractable for more than 15% and another electron donor compound which is extractable for more than 35%.

R₁ and R₂ are preferably C₁-C₈ alkyl, cycloalkyl, aryl, arylalkyl and alkylaryl groups. Particularly preferred are the compounds in which R₁ and R₂ are selected from primary alkyls and in particular branched primary alkyls. Examples of suitable R₁ and R₂ groups are methyl, ethyl, n-propyl, n-butyl, isobutyl, neopentyl, 2-ethylhexyl. Particularly preferred are ethyl, isobutyl, and neopentyl.

Particularly preferred are the compounds in which the R₃ and/or R₄ radicals are secondary alkyls like isopropyl, sec-butyl, 2-pentyl, 3-pentyl or cycloakyls like cyclohexyl, cyclopentyl, cyclohexylmethyl.

Examples of the above-mentioned compounds are the (S,R) (S,R) forms pure or in mixture, optionally in racemic form, of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, diethyl 2,3-dicyclohexylsuccinate.

Among the extractable electron donor compounds particularly preferred are the esters of mono or dicarboxylic organic acids such as benzoates, malonates, phthalates and succinates different from those of formula (I). Among malonates particularly preferred are those of formula (II):

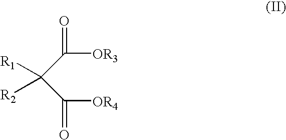

where R₁ is H or a C₁-C₂₀ linear or branched alkyl, alkenyl, cycloalkyl, aryl, arylalkyl or alkylaryl group, R₂ is a C₁-C₂₀ linear or branched alkyl, alkenyl, cycloalkyl, aryl, arylalkyl or alkylaryl group, R₃ and R₄, equal to, or different from, each other, are C₁-C₂₀ linear or branched alkyl groups or C₃-C₂₀ cycloalkyl groups.

Preferably, R₃ and R₄ are primary, linear or branched C₁-C₂₀ alkyl groups, more preferably they are primary branched C₄-C₂₀ alkyl groups such as isobutyl or neopentyl groups. R₂ is preferably, in particular when R₁ is H, a linear or branched C₃-C₂₀ alkyl, cycloalkyl, or arylalkyl group; more preferably R₂ is a C₃-C₂₀ secondary alkyl, cycloalkyl, or arylalkyl group.

Preferred esters of aromatic carboxylic acids are selected from C₁-C₂₀ alkyl or aryl esters of benzoic and phthalic acids, possibly substituted. The alkyl esters of the said acids being preferred. Particularly preferred are the C₁-C₆ linear or branched alkyl esters. Specific examples are ethylbenzoate, n-butylbenzoate, p-methoxy ethylbenzoate, p-ethoxy ethylbenzoate, isobutylbenzoate, ethyl p-toluate, diethyl phthalate, di-n-propyl phthalate, di-n-butyl phthalate, di-n-pentyl phthalate, di-i-pentyl phthalate, bis(2-ethylhexyl) phthalate, ethyl-isobutyl phthalate, ethyl-n-butyl phthalate, di-n-hexyl phthalate, di-isobutylphthalate. Certain subclasses of succinates different from those of formula (I) can be used as extractable donors according to the present invention.
One of the preferred groups of compounds is that described by the formula (III)

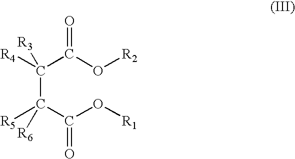

in which R₃ to R₅ are hydrogen and R₆ is a branched alkyl, cycloalkyl, aryl, arylalkyl and alkylaryl radical having from 3 to 10 carbon atoms. Particularly preferred are the compounds in which R₆ is a branched primary alkyl group or a cycloalkyl group having from 3 to 10 carbon atoms. Specific examples are diethyl sec-butylsuccinate, diethyl thexylsuccinate, diethyl cyclopropylsuccinate, diethyl norbornylsuccinate, diethyl (10-)perhydronaphthylsuccinate, diethyl trimethylsilylsuccinate, diethyl methoxysuccinate, diethyl p-methoxyphenylsuccinate, diethyl p-chlorophenylsuccinate diethyl phenylsuccinate, diethyl cyclohexylsuccinate, diethyl benzylsuccinate, diethyl (cyclohexylmethyl)succinate, diethyl t-butylsuccinate, diethyl isobutylsuccinate, diethyl isopropylsuccinate, diethyl neopentylsuccinate,

Another subclass of preferred compounds is that of formula (III) in which R₃ and R₄ are hydrogen and R₅ and R₆ are selected from C₁-C₂₀ linear or branched alkyl, alkenyl, cycloalkyl, aryl, arylalkyl or alkylaryl group, optionally containing heteroatoms. Specific examples of suitable 2,2-disubstituted succinates are: diethyl 2,2-dimethylsuccinate, diethyl 2-ethyl-2-methylsuccinate, diethyl 2-benzyl-2-isopropylsuccinate, diethyl 2-(cyclohexylmethyl)-2-isobutylsuccinate, diethyl 2-cyclopentyl-2-n-propylsuccinate, diethyl 2,2-diisobutylsuccinate, diethyl 2-cyclohexyl-2-ethylsuccinate, diethyl 2-isopropyl-2-methylsuccinate, diethyl 2,2-diisopropyl diethyl 2-isobutyl-2-ethylsuccinate, diethyl 2-(1,1,1-trifluoro-2-propyl)-2-methylsuccinate, diethyl 2-isopentyl-2-isobutylsuccinate, diethyl 2-phenyl-2-n-butylsuccinate, diisobutyl 2,2-dimethylsuccinate, diisobutyl 2-ethyl-2-methylsuccinate, diisobutyl 2-benzyl-2-isopropylsuccinate, diisobutyl 2-(cyclohexylmethyl)-2-isobutylsuccinate, diisobutyl 2-cyclopentyl-2-n-propylsuccinate. Moreover, also usable are the (S,S), (R,R) or meso forms of the succinates of formula (I) described above.

Mixtures of different succinates of formula (I) can be used as non-extractable donors, and mixtures of extractable donors can be used as well. In particular, we found it particularly advantageous the use of the succinates of formula (I) in which R₃ and R₄ are identical both as extractable and non extractable electron donors. Actually, the compounds of formula (I) in which R₃ and R₄ are the same can be mixtures of meso (S,S and R,R) and rac-form (S,R and R,S) as a direct result of their preparation process. Therefore, in certain cases the skilled in the art is already provided with a mixture of extractable and non-extractable donors to be used in the preparation of the catalyst of the invention. Depending on the peculiar amounts of the single donors in the mixtures, additional amounts of extractable donors could be requested in order to bring the final composition of the catalyst within the limits set forth above.

It has been found particularly interesting the use of a catalyst component comprising the rac-form of diethyl or diisobutyl 2,3-diisopropylsuccinate as non-extractable donor and the meso form of diethyl or diisobutyl 2,3-diisopropylsuccinate together with an alkylphthalate as extractable donors.

As explained above, the catalyst components of the invention comprise, in addition to the above electron donors, a titanium compound having at least a Ti-halogen bond and a Mg halide. The magnesium halide is preferably MgCl₂ in active form which is widely known from the patent literature as a support for Ziegler-Natta catalysts. U.S. Pat. No. 4,298,718 and U.S. Pat. No. 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra in which the most intense diffraction line that appears in the spectrum of the non-active halide is diminished in intensity and is replaced by a halo whose maximum intensity is displaced towards lower angles relative to that of the more intense line.

The preferred titanium compounds used in the catalyst component of the present invention are TiCl₄ and TiCl₃; furthermore, also Ti-haloalcoholates of formula Ti(OR)_{n-y}X_{y} can be used, where n is the valence of titanium, y is a number between 1 and n−1 X is halogen and R is a hydrocarbon radical having from 1 to 10 carbon atoms.

The preparation of the solid catalyst component can be carried out according to several methods.

According to a preferred method, the solid catalyst component can be prepared by reacting a titanium compound of formula Ti(OR)_{n-y}X_{y}, where n is the valence of titanium and y is a number between 1 and n, preferably TiCl₄, with a magnesium chloride deriving from an adduct of suitably small particle size having formula MgCl₂pROH, where p is a number between 0.1 and 6, preferably from 2 to 3.5, and R is a hydrocarbon radical having 1-18 carbon atoms. The adduct can be prepared in suitable spherical form and small particle size by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of small spherical particles. A suitably small average particle size is obtained by providing to the system high energy shear stresses by way of maintaining in the mixer conditions such as to have a Reynolds (R_{EM}) number 10,000 and 80,000, preferably between 30,000 and 80,000. The type of flow of a liquid inside a mixer is described by the above mentioned modified Reynolds number (Re_{M}) which is defined by the formula Re═NL²·d/η in which N is the number of revolutions of the stirrer per unit time, L is the characteristic length of the stirrer while d is the density of the emulsion and η is the dynamic viscosity. Due to what described above, it results that one of the methods to reduce the particle size of the adduct is that of increasing the number of revolutions of the stirrer. According to WO02/051544, the description of which is herein enclosed by reference, particularly good results are obtained when high Reynolds numbers are maintained also during the transfer of the emulsion at the quenching stage and during the quench as well. When providing sufficient energy to the system, it can be obtained spherical particles of the adduct that already have an average diameter sufficiently small able to generate a solid catalyst component of suitable size to obtain, upon reaction with the titanium compound a catalyst component with average particle size lower than 40μ.

The so obtained adduct particles have average particle size determined with the method described in the characterization section below, ranging from 5 to 45 μm preferably from 5 to 30 μm and preferably a particle size distribution (SPAN) lower than 1.2, calculated with the formula

$$\frac{P 90 - P 10}{P 50}$$

where, in a particle size distribution curve determined according to the same method, wherein P90 is the value of the diameter such that 90% of the total volume of particles have a diameter lower than that value; P10 is the value of the diameter such that 10% of the total volume of particles have a diameter lower than that value and P50 is the value of the diameter such that 50% of the total volume of particles have a diameter lower than that value.

The particle size distribution can be inherently narrow by following the teaching of WO02/051544. However, in alternative to this method or to further narrow the SPAN, largest and/or finest fractions can be eliminated by appropriate means such as mechanical sieving and/or elutriation in a fluid stream.

The adduct particles can be directly reacted with Ti compound or it can be previously subjected to thermal controlled dealcoholation (80-130° C.) so as to obtain an adduct in which the number of moles of alcohol is generally lower than 3 preferably between 0.1 and 2.5. The reaction with the Ti compound can be carried out by suspending the adduct particles (dealcoholated or as such) in cold TiCl₄ (generally 0° C.); the mixture is heated up to 80-130° C. and kept at this temperature for 0.5-2 hours. The treatment with TiCl₄ can be carried out one or more times. The electron donor compounds can be added during the treatment with TiCl₄. They can be added together in the same treatment with TiCl₄ or separately in two or more treatments.

The solid catalyst components obtained according to the above method show a surface area (by B.E.T. method) generally between 20 and 500 m²/g and preferably between 50 and 400 m²/g, and a total porosity (by B.E.T. method) higher than 0.2 cm³/g preferably between 0.2 and 0.6 cm³/g.

Regardless to the preparation method, the desired electron donor compounds and in particular those selected from esters of carboxylic acids, can be added as such or, in an alternative way, it can be obtained in situ by using an appropriate precursor capable to be transformed in the desired electron donor compound by means, for example, of known chemical reactions such as esterification, transesterification, etc

The final amount of the two or more electron donor compounds is such that the molar ratio with respect to the MgCl₂ is from 0.01 to 1, preferably from 0.05 to 0.5.

The solid catalyst components according to the present invention are converted into catalysts for the polymerization of olefins by reacting them with organoaluminum compounds according to known methods.

In particular, it is an object of the present invention a catalyst for the polymerization of olefins CH₂═CHR, in which R is hydrogen or a hydrocarbyl radical with 1-12 carbon atoms, comprising the product of the reaction between:

(i) the solid catalyst component as disclosed above,
(ii) an organo-metal compound and optionally,
(iii) an external electron donor compound.

The organo-metal compound (ii) is preferably chosen among alkyl-Al compounds and in particular among the trialkyl aluminum compounds such as for example triethylaluminum, triisobutylaluminum, tri-n-butylaluminum, tri-n-hexylaluminum, tri-n-octylaluminum. It is also possible to use alkylaluminum halides, alkylaluminum hydrides or alkylaluminum sesquichlorides, such as AlEt₂Cl and Al₂Et₃Cl₃, possibly in mixture with the above cited trialkylaluminums.

Suitable external electron-donor (iii) include silanes, ethers, esters, amines, heterocyclic compounds and ketones. A particular class of preferred external donor compounds is that of silanes of formula Rₐ⁵R_{b}⁶Si(OR⁷)_{c}, where a and b are integers from 0 to 2, c is an integer from 1 to 4 and the sum (a+b+c) is 4; R⁵, R⁶, and R⁷, are alkyl, alkylen, cycloalkyl or aryl radicals with 1-18 carbon atoms optionally containing heteroatoms. Particularly preferred are the silicon compounds in which a is 1, b is 1, c is 2, at least one of R⁵ and R⁶ is selected from branched alkyl, cycloalkyl or aryl groups with 3-10 carbon atoms optionally containing heteroatoms and R⁷ is a C₁-C₁₀ alkyl group, in particular methyl. Examples of such preferred silicon compounds are methylcyclohexyldimethoxysilane, dicyclopentyldimethoxysilane.

Therefore, it constitutes a further object of the present invention a process for the (co)polymerization of olefins CH₂═CHR, in which R is hydrogen or a hydrocarbyl radical with 1-12 carbon atoms, carried out in the presence of a catalyst comprising the product of the reaction between:

(i) the solid catalyst component above described;
(ii) an alkylaluminum compound and,
(iii) optionally an electron-donor compound (external donor).

The olefin is preferably chosen among ethylene, propylene, butene-1, pentene-1, hexene-1 octene-1 and mixtures thereof. Preferably the process regards the polymerization of propylene optionally in mixture with ethylene and/or higher alpha olefins to give isotactic propylene homo or copolymers. The said catalysts can also be used in the preparation of heterophasic copolymers comprising, in addition to the said isotactic homo or copolymers containing up to 10% wt of other olefins, from 10 to 50% wt, based on the total amount of said heterophasic copolymers, of an olefin copolymer having a solubility in xylene at room temperature higher than 70% wt. Preferably the olefin copolymer is chosen among propylene/ethylene copolymers and ethylene/butene-1 copolymers.

The polymerization process can be carried out according to known techniques for example slurry polymerization using as diluent an inert hydrocarbon solvent, or bulk polymerization using the liquid monomer (for example propylene) as a reaction medium. However, as mentioned above, it has been found particularly advantageous the use of such catalyst systems in the gas-phase polymerization process where they allow obtaining high yields in conjunction with valuable morphological properties expressed by high values of bulk density.

The process can be carried out operating in one or more fluidized or mechanically agitated bed reactors. Typically, in the fluidized bed reactors the fluidization is obtained by a stream of fluidization gas the velocity of which is not higher than transport velocity. As a consequence, the bed of fluidized particles can be found in a more or less confined zone of the reactor.

As explained before, the catalyst of the invention can successfully be used in the fluidized-bed reactors without being prepolymerized. Accordingly they can be used in gas-phase polymerization plant not provided with a prepolymerization section. Notwithstanding that, it allows obtaining polymers, in particular propylene polymers, with bulk densities higher than 0.40 g/cm³ in conjunction with activities higher than 10 Kg/g of cat and, surprisingly with a percentage of fine particles (i.e., with diameter or radius lower than 125 μm lower than 2% wt.

The polymerization is generally carried out at temperature of from 40 to 120° C., preferably of from 40 to 100° C. and more preferably from 50 to 90° C. The polymerization is carried out in gas-phase the operating pressure is generally between 0.5 and 5 MPa, preferably between 1 and 4 MPa. In the bulk polymerization the operating pressure is generally between 1 and 8 MPa preferably between 1.5 and 5 MPa.

The following examples are given in order to better illustrate the invention without limiting it.

### Characterizations

### Test for the Extractability of the Electron Donor (ED) Compounds

### A. Preparation of the Solid Catalyst Component

Into a 500 ml four-necked round flask, purged with nitrogen, 250 ml of TiCl₄ were introduced at 0° C. While stirring, 10.0 g of microspheroidal MgCl₂*2.8C₂H₅OH(prepared according to the method described in ex. 2 of U.S. Pat. No. 4,399,054 but operating at 3,000 rpm instead of 10,000) were introduced. 4.4 mMols of the selected electron donor compound were also added.

The temperature was raised to 100° C. and maintained at that temperature for 120 min. Then, the stirring was discontinued, the solid product was allowed to settle and the supernatant liquid was siphoned off.

250 ml of fresh TiCl₄ were added. The mixture was reacted at 120° C. for 60 min under stirring and, then, the supernatant liquid was siphoned off. The solid (A) was washed six times with anhydrous hexane (6×100 ml) at 60° C., dried under vacuum and analyzed for the quantitative determination of Mg and electron donor compound. The type of electron donor compound and its molar ratio with respect to Mg (ratio A) are reported in Table 1.

### B. Treatment of Solid A

In a 250 ml jacketed glass reactor with mechanical stirrer and filtration septum are introduced under nitrogen atmosphere 190 ml of anhydrous n-hexane, 19 mMmoles of AlEt₃ and 2 gr of the catalyst component prepared as described in A. The mixture is heated at 60° C. for 1 hour under stirring (stirring speed at 400 rpm). After that time the mixture is filtered, washed four times with n-hexane at 60° C. and finally dried under vacuum for 4 hours at 30° C. The solid is then analyzed for the quantitative determination of Mg and electron donor compound. The type of electron donor compound and its molar ratio with respect to Mg (ratio B) are reported in Table 1. The extractability of the electron donor compound is calculated according to the following formula: % of ED extracted=(Ratio A−Ratio B)/Ratio A

### Determination of X.I.

2.5 g of polymer were dissolved in 250 ml of o-xylene under stirring at 135° C. for 30 minutes, then the solution was cooled to 25° C. and after 30 minutes the insoluble polymer was filtered. The resulting solution was evaporated in nitrogen flow and the residue was dried and weighed to determine the percentage of soluble polymer and then, by difference, the X.I. %.

### Average Particle Size of the Adduct and Catalysts

Determined by a method based on the principle of the optical diffraction of monochromatic laser light with the “Malvern Instr. 2600” apparatus. The average size is given as P50.

### Average Particle Size of the Polymers

Determined through the use Tyler Testing Sieve Shaker RX-29 Model B available from Combustion Engineering Endecott provided with a set of six sieves, according to ASTM E-11-87, of number 5, 7, 10, 18, 35, and 200 respectively.

### EXAMPLES

### Example 1

### Preparation of the Solid Precursor Particles

300 g of a molten adduct of formula MgCl₂.2.8EtOH and 900 g of white mineral oil OB55 are introduced into a 3 liter jacketed container equipped with a stirrer. The mixture is kept under stirring at a temperature of 125° C. for 0.5 hours. The stirring speed was 2000 RPM. The container is then pressurized and the emulsion is transferred into a pipe, maintained at a temperature of 125° C., which transfers the emulsion into a cooling bath containing hexane at a temperature of 10° C.

The solid adduct particles are collected by filtration and dried. Their average particle size was 22 μm, the SPAN was 0.95. The so obtained adduct particles were then subject to a nitrogen flow at a gradually increasing temperature from 50 to 100° C. until the alcohol content of the adduct is about 48% wt.

### Preparation of Solid Catalyst Component

Into a 1 liter four-necked round flask, purged with nitrogen, 800 ml of TiCl₄ were introduced at 0° C. While stirring, 56.0 g of microspheroidal adduct prepared as described above were introduced. As internal donor(s), rac diethyl 2,3-diisopropylsuccinate and diisobutylphthalate at Mg/donor molar ratio of 31 and 11 respectively were introduced at 40° C. The temperature was raised to 100° C. and maintained for 1 hour. Then, the stirring was discontinued, the solid product was allowed to settle and the supernatant liquid was siphoned off.

Then, 800 ml of fresh TiCl₄ were added. The mixture was reacted at 120° C. for 30 min and, then, the supernatant liquid was siphoned off. Then this last treatment with TiCl₄ was repeated under the same conditions. The solid was washed six times with anhydrous hexane (6×100 ml) at 60° C. Finally, the solid was dried under vacuum and analyzed. The final catalyst having a particle size of 22.5 μm, contained 2.5% of Ti, 10.9% wt of diisobutylphthalate and 4.3% wt of diethyl 2,3-diisopropylsuccinate.

### Gas-Phase Propylene Polymerization

### Polymerization Procedure for the Preparation of Propylene Homopolymers

Into a gas phase polymerization reactor a polypropylene is produced by feeding separately in a continuous and constant flow the catalyst component in a propylene flow, the aluminum triethyl (TEAL), dicyclopentyldimethoxysilane (DCPMS) as external donor, in the amounts reported in table 2. The polymerization temperature is 75° C. and the total pressure 24 barg.

The polymer particles exiting the reactor are subjected to a steam treatment to remove the reactive monomers and volatile substances, and then dried. The results are shown in table 2.

### Comparison Example 1

### Preparation of the Solid Precursor Particles

The preparation was carried out as described in example 1 with the difference that a lower stirring speed in the preparation of the solid precursor particles was adopted. As a consequence, the average particle size was 72 μm.

### Preparation of Solid Catalyst Component

The preparation was carried out as described in example 1. The so obtained solid catalyst resulted to have an average particle size of 70 μm and contained 1.8% of Ti, 2.7% of diisobutylphthalate and 2.4% wt of diethyl 2,3-diisopropylsuccinate. The said catalyst was used in propylene gas-phase polymerization under the same conditions disclosed in example 1. The results are shown in table 2.

### Comparison Example 2

The catalyst was prepared under the same conditions disclosed in example 1 with the difference that only diisobutylphtahalate was used as internal donor at a Mg/donor molar ratio of 7. The so obtained solid catalyst resulted to have an average particle size of 22.8 μm and contained 3% of Ti, and 14.3% of diisobutylphthalate. The said catalyst was used in propylene gas-phase polymerization under the same conditions disclosed in example 1. The results are shown in table 2.

TABLE 1

| | ED | | |
|---|---|---|---|
| | ED/Mg ratio A | ED/Mg ratio B | |
| | (mMols/gram | (mMols/gram | ED extracted |
| Type | atom) | atom) | (mol %) |
| rac Diethyl 2,3- | 65.2 | 62.8 | 4 |
| diisopropylsuccinate | | | |
| Diisobutyl phthalate | 48.8 | 8.8 | 82 |

TABLE 2

| Example No. | | 1 | Comp. 1 | Comp. 2 |
|---|---|---|---|---|
| TEAL/DCPMS | wt ratio | 10 | 10 | 10 |
| TEAL/catalyst | wt ratio | 10 | 10 | 10 |
| Mileage | Kg/g | 13.4 | 2.3 | 16.2 |
| Xylene insolubles | wt %/ | 98.8 | 97.2 | 98.1 |
| Bulk Density | g/cm³ | 0.43 | 0.30 | 0.4 |
| Fines | | 1.4 | 0.8 | 2.8 |
| <125 μm | | | | |

1. Solid catalyst component having an average particle size of at most 40 μm comprising:
a magnesium halide;
a titanium compound having at least a Ti-halogen bond and at least two electron donor compounds one of which being present in an amount from 15 to 50% by mol with respect to the total amount of donors and selected from succinates of formula (I): 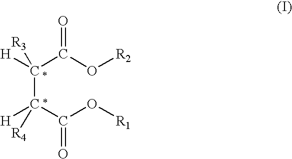
in which the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C₃-C₂₀ cycloalkyl, C₅-C₂₀ aryl, arylalkyl or alkylaryl group with the proviso that at least one of them is a branched alkyl, said compounds being, with respect to the two asymmetric carbon atoms identified in the structure of formula (I), stereoisomers of the type (S,R) or (R,S); and
at least another electron donor compound which is extractable for more than 30% by mol.

2. The catalyst component according to claim 1 wherein the amount of succinates of formula (I) is between 20 and 45 by mol with respect to the total amount of the electron donor compounds.

3. The catalyst component according to claim 1 wherein the succinate of formula (I) is chosen from the (S,R) (S,R) forms pure or in mixture, optionally in racemic form, of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, or diethyl 2,3-dicyclohexylsuccinate.

4. The catalyst component according to claim 1 further comprising an average particle size lower than 35 μm.

5. The catalyst component according to claim 1 wherein the extractable electron donor compounds are selected from esters of mono or dicarboxylic organic acids

6. The catalyst component according to claim 5 wherein the extractable electron donor compounds are selected from benzoates, malonates, phthalates or succinates different from those of formula (I).

7. The catalyst component according to claim 6 wherein the extractable donor is selected from phthalates.

8. A catalyst for the polymerization of olefins comprising the product of the reaction between:
(i) a solid catalyst component having an average particle size of at most 40 μm comprising:
a magnesium halide;
a titanium compound having at least a Ti-halogen bond and at least two electron donor compounds one of which being present in an amount from 15 to 50% by mol with respect to the total amount of donors and selected from succinates of formula (I): 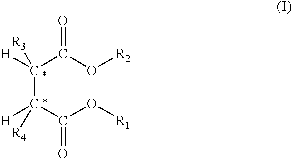
in which the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C₃-C₂₀ cycloalkyl, C₅-C₂₀ aryl, arylalkyl or alkylaryl group, with the proviso that at least one of them is a branched alkyl, said compounds being, with respect to the two asymmetric carbon atoms identified in the structure of formula (I), stereoisomers of the type (S,R) or (R,S); and
at least another electron donor compound which is extractable for more than 30% by mol;
(ii) an organo-metal compound; and
(iii) an external electron donor compound.

9. A process for the polymerization of olefins carried out in the presence of a catalyst comprising the product of the reaction between:
(i) a solid catalyst component having an average particle size of at most 40 μm comprising:
a magnesium halide;
a titanium compound having at least a Ti-halogen bond and at least two electron donor compounds one of which being present in an amount from 15 to 50% by mol with respect to the total amount of donors and selected from succinates of formula (I): 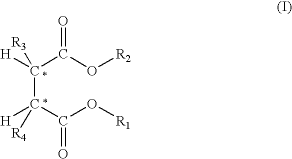
in which the radicals R₁, and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C₃-C₂₀ cycloalkyl, C₅-C₂₀ aryl, arylalkyl or alkylaryl group, with the proviso that at least one of them is a branched alkyl, said compounds being, with respect to the two asymmetric carbon atoms identified in the structure of formula (I), stereoisomers of the type (S,R) or (R,S); and
at least another electron donor compound which is extractable for more than 30% by mol;
(ii) an organo-metal compound; and
(iii) an external electron donor compound.

10. The process according to claim 9 carried out in gas-phase.

11. The process according to claim 10 wherein propylene is polymerized in a fluidized-bed reactor.
